(19) United States
(12) Patent Application Publication
(10) Pub. No.: US 2022/0416242 A1
(43) Pub. Date: Dec. 29, 2022

(54) ALL-SOLID- STATE BATTERY

(71) Applicant: TDK CORPORATION, Tokyo (JP)

(72) Inventors: Teiichi TANAKA, Tokyo (JP); Takeo TSUKADA, Tokyo (JP)

(73) Assignee: TDK CORPORATION, Tokyo (JP)

(21) Appl. No.: 17/773,341

(22) PCT Filed: Oct. 30, 2020
(86) PCT No.: PCT/JP2020/040889

§ 371 Date: Apr. 29, 2022

(30) Foreign Application Priority Data
Nov. 7, 2019 (JP) 2019-201864

(51) Int. Cl. H01M 4/583; H01M 10/0562

(52) U.S. Cl. CPC H01M 4/583; H01M 10/0562

(57) ABSTRACT

An all-solid-state battery includes an electrode layer, a solid electrolyte layer, an intermediate layer provided at least in a part between the electrode layer and the solid electrolyte layer, the electrode layer includes a current collector layer and an active material layer, the active material layer includes an active material and a carbon material, the intermediate layer has ionic conductivity, the carbon content in the intermediate layer is less than the carbon content in the active material layer.

### TECHNICAL FIELD

The present invention relates to an all-solid-state battery,

Priority is claimed on Japanese Patent Application No, 2019-201864, filed Nov. 7, 2019, the content of which is incorporated herein by reference.

### BACKGROUND ART

In recent years, the development of electronics technology has been remarkable, and portable electronic devices have been made smaller and lighter, thinner, and more multifunctional. Along with this, there is a strong demand for batteries that serve as power supplies for electronic devices to be smaller and lighter, thinner, and more reliable. Currently, in lithium ion secondary batteries that are generally used, an electrolyte (electrolytic solution) such as an organic solvent has been conventionally used as a medium for moving ions. However, in the battery having the above configuration, there is a risk that the electrolytic solution may leak out. Further, since the organic solvent and the like used in the electrolytic solution are flammable substances, a battery with higher safety is required.

As one measure for improving the safety of the battery, it has been proposed to use a solid electrolyte as an electrolyte instead of the electrolytic solution. Further, development of an all-solid-state battery in which a solid electrolyte is used as an electrolyte and other components are also composed of solids is underway.

Patent Literature 1 proposes an all-solid state produced by an industrially feasible mass-produced manufacturing method in which each member is made into a sheet, laminated, and then fired at the same time using an oxide-based solid electrolyte stable in the air. However, for practical use, it was necessary to improve the element body strength in order to secure the durability against vibrations and shocks that may occur in the living environment while improving the battery characteristics.

For example, Patent Literature 2 discloses that an all-solid-state battery with an improved capacity can be obtained by using a carbon material having a high sintering start temperature.

However, the method described in Patent Literature 2. could not obtain a sintered body having sufficient element body strength.

### CITATION LIST

### Patent Literature

[Patent Literature 1]

PCT International Publication No. 2007/135790

[Patent Literature 2]

PCT International Publication No, 2013/038948

### SUMMARY OF INVENTION

### Technical Problem

The present invention has been made in view of the above problems, and provides an all-solid-state battery having excellent element body strength.

We found that the presence of the carbon material at the interface between the active material layer and the solid electrolyte makes it impossible to bond the carbon material and the solid electrolyte, creating a gap, and this gap becomes the starting point, making it easy for cracks and breakage to occur.

### Solution to Problem

An all-solid-state battery according to one aspect of the present invention includes an electrode layer, a solid electrolyte layer, an intermediate layer provided at least in a part between the electrode layer and the solid electrolyte layer, the electrode layer has a current collector layer and an active material layer, the active material layer has an active material and a carbon material, the intermediate layer has ionic conductivity, the carbon content in the intermediate layer is less than the carbon content in the active material layer.

Further, in the all-solid-state battery according to the above aspect, the ratio T1/T2 of the thickness T1 of the intermediate layer to the thickness T2 of the active material layer may satisfy 0.05≤T1/T2≤1.2.

Further, in the all-solid-state battery according to the above aspect, the carbon content in the intermediate layer may be 100 ppm or more and 50,000 ppm or less.

Further, in the all-solid-state battery according to the above aspect, the intermediate layer may be composed of elements contained the active material layer and elements contained in the solid electrolyte layer.

Further, in the all-solid-state battery according to the above aspect, the content of the carbon material in the active material layer may increase as the distance from the surface in contact with the intermediate layer increases.

Further, in the all-solid-state battery according to the above aspect, the carbon contents in the active material layer, the solid electrolyte layer, and the intermediate layer may be higher in the order of the active material layer, the intermediate layer, and the solid electrolyte layer.

Further, in the all-solid-state battery according to the above aspect, the current collector layer may contain carbon.

Further, in the all-solid-state battery according to the above aspect, the carbon material may contain graphite or carbon nanotubes.

### Advantageous Effects of Invention

According to the present invention, it is possible to provide an all-solid-state battery having excellent element body strength.

### BRIEF DESCRIPTION OF DRAWING

FIG. 1 is a schematic cross-sectional view of an all-solid-state battery according to the present embodiment.

FIG. 2 is an enlarged view of an all-solid-state battery according to the present embodiment.

FIG. 3 is an enlarged view of an all-solid-state battery according to the first modification.

### DESCRIPTION OF EMBODIMENTS

An all-solid-state battery of the present invention will be described in detail below with reference to the drawings as appropriate. In the drawings used in the following description, in order to facilitate understanding of the features of the embodiment, for the sake of convenience, enlarged characteristic portions are illustrated in some cases. Therefore, dimensional ratios between the constituent elements and the like may be different from the actual dimension ratio in some cases. The materials, dimensions, and the like exemplified in the following description are mere examples and the present invention is not limited thereto and the present invention can be implemented through appropriate modifications without departing from the gist of the present invention.

The directions are defined. The direction in which the positive electrode layer 1 and the negative electrode layer 2 described later are laminated is defined as the z direction. Further, one of the in-plane directions in which the positive electrode layer 1 and the negative electrode layer 2 described later, spread is defined as the x direction, and the direction orthogonal to the x direction is defined as the v direction.

### (All-Solid-State Battery)

FIG. 1 is an enlarged cross-sectional schematic view of a main part of the all-solid-state battery according to the first embodiment. As shown in FIG. 1, the all-solid-state battery 10 has a laminate 5. The laminate 5 includes a plurality of electrode layers. The all-solid-state battery according to the present embodiment has a plurality of first electrode layers, a plurality of second electrode layers, and a solid electrolyte layer 4 located between the first electrode layer and the second electrode layer. The intermediate layer 3 is provided at least in a part of the portion where the first electrode layer and the solid electrolyte layer 4 are in contact with each other and the second electrode layer and the solid electrolyte layer 4 are in contact with each other. The positive electrode layer 1 is an example of the first electrode layer, and the negative electrode layer 2 is an example of the second electrode layer. One of the first electrode layer and the second electrode layer functions as a positive electrode, and the other functions as a negative electrode. The positive electrode layer 1 and the negative electrode layer 2 are connected to external terminals having corresponding polarities, respectively, and the positive electrode layer 1 and the negative electrode layer 2 do not come into contact with each other.

The positive electrode layer 1 is connected to the first external terminal 6, and the negative electrode layer 2 is connected to the second external terminal 7, respectively. The first external terminal 6 and the second external terminal 7 are electrical contacts with the outside.

### (Laminated Body)

The laminated body 5 has a plurality of positive electrode layers 1, a plurality of negative electrode layers 2, a plurality of intermediate layers 3, and a plurality of solid electrolyte layers 4. An intermediate layer 3 and a solid electrolyte layer 4 are located between the positive electrode layer 1 and the negative electrode layer 2, respectively. The all-solid-state battery 10 is charged and discharged by exchanging lithium ions between the positive electrode layer 1 and the negative electrode layer 2 via the solid electrolyte layer 4.

### (Positive Electrode Layer and Negative Electrode Layer)

For example, a plurality of positive electrode layers 1 and a plurality of negative electrode layers 2 are provided in the laminated body 5. The positive electrode layer 1 and the negative electrode layer 2 are alternately laminated in the z direction with the solid electrolyte layer 4 interposed therebetween. Each of the positive electrode layer 1 and the negative electrode layer 2. spreads in the xy plane. The first end of the positive electrode layer 1 is connected to the first external terminal 6, and the second end extends toward the second external terminal 7. The second end portion of the positive electrode layer 1 is not connected to the second external terminal 7. The first end portion of the negative electrode layer 2 is connected to the second external terminal 7, and the second end portion extends toward the first external terminal 6. The second end portion of the negative electrode layer 2 is not connected to the first external terminal 6. A material similar to that of the solid electrolyte layer 4 exists between the positive electrode layer 1 and the second external terminal 7 and between the negative electrode layer 2 and the first external terminal 6.

The positive electrode layer 1 has a positive electrode current collector layer 1A and a positive electrode active material layer 1B. The negative electrode layer 2 has a negative electrode current collector layer 2A and a negative electrode active material layer 2B.

The positive electrode current collector layer 1A and the negative electrode current collector layer 2A spread in the xy plane. The positive electrode current collector layer 1A and the negative electrode current collector layer 2A contain a material having excellent conductivity. The positive electrode current collector layer 1A and the negative electrode current collector layer 2A are portions containing 50% or more of a material having excellent conductivity when the all-solid-state battery 10 is divided along the xy plane. Materials with excellent conductivity are, for example, silver, palladium, gold, platinum, aluminum, copper and nickel. Copper does not easily react with positive electrode active materials, negative electrode active materials and solid electrolytes. For example, if copper is used for the positive electrode current collector layer 1A and the negative electrode current collector layer 2A, the internal resistance of the all-solid-state battery 10 can be reduced. The materials constituting the positive electrode current collector layer 1A and the negative electrode current collector layer 2A may be the same or different.

The positive electrode current collector layer 1A may contain a positive electrode active material described later. The negative electrode current collector layer 2A may contain a negative electrode active material described later. The content ratio of the active material contained in each current collector layer is not particularly limited as long as it functions as a current collector. The volume ratio of the conductive material and the positive electrode active material in the positive electrode current collector layer 1A is, for example, in the range of 90:10 to 70:30. Similarly, the volume ratio of the conductive material and the negative electrode active material in the negative electrode current collector layer 2A is, for example, in the range of 90:10 to 70:30. When the positive electrode current collector layer 1A and the negative electrode current collector layer 2A contain the positive electrode active material and the negative electrode active material, respectively, the adhesion between the positive electrode current collector layer 1A and the positive electrode active material layer 1B and the adhesion between the negative electrode current collector layer 2A and the negative electrode active material layer 2B is improved.

The positive electrode active material layer 1B and the negative electrode active material layer 2B spread in the xy plane. The positive electrode active material layer 1B is formed on one side or both sides of the positive electrode current collector layer 1A. The positive electrode active material layer 1B may not be present on the surface of the positive electrode current collector layer 1A on the side where the opposing negative electrode layer 2 does not exist. Further, the negative electrode active material layer 2B is formed on one side or both sides of the negative electrode current collector layer 2A. The negative electrode active material layer 2B may not be present on the surface of the negative electrode current collector layer 2A on the side where the opposing positive electrode layer 1 does not exist. For example, the positive electrode layer 1 or the negative electrode layer 2 located at the uppermost layer or the lowermost layer of the laminated body 4 may not have the positive electrode active material layer 1B or the negative electrode active material layer 2B on one side.

The positive electrode active material layer 1B and the negative electrode active material layer 2B include an active material that transfers electrons during charging and discharging, and a carbon material that facilitates the movement of electrons. The positive electrode active material layer 1B contains a positive electrode active material. The negative electrode active material layer 2B contains a negative electrode active material. The positive electrode active material layer 1B and the negative electrode active material layer 2B may contain a conductive additive, an ion conductive assistant, a binder and the like, respectively. It is preferable that the positive electrode active material and the negative electrode active material can efficiently insert and desorb lithium ions.

The carbon content contained in the positive electrode active material layer 1B and the negative electrode active material layer 2B can be, for example, 5,000 ppm or more and 100,000 ppm or less. Within this range, an all-solid-state battery having excellent element body strength can be obtained while improving the capacity. Further, the carbon content is preferably 10,000 ppm or more and 70,000 ppm or less, and more preferably 20,000 ppm or more and 50,000 ppm or less.

The positive electrode active material and the negative electrode active material are, for example, a transition metal oxide and a transition metal composite oxide. Specifically, the positive electrode active material and the negative electrode active material are, for example, a lithium manganese composite oxide Li₂MnₐMa₁ₐO₃ (0.8≤a≤1; Ma═Co or Ni), lithium cobaltate (LiCoO₂), lithium nickelate (LiNiO₂), a lithium manganese spinel (LiMn₂O₄), a composite metal oxide represented by a general formula: LiNiₓCo_{y}Mn_{z}O₂ (x+y+z=1; 0≤x≤1, 0≤y≤1, and 0≤z≤1), a lithium vanadium compound (LiV₂O₅), an olivine type LiMhPO₄ (where, Mb is at least one element selected from Co, Ni, Mn, Fe, Mg, Nb, Ti, Al, and Zr), a lithium vanadium phosphate (Li₃V₂(PO₄)₃, Li₂VTi(PO₄)₃, LiVOPO₄), a Li-excess solid solution positive electrode represented by Li₂MnO₃—LiMcO₂ (Mc=Mn, Co, or Ni), lithium titanate (TiO₂, Li₄Ti₅O₁₂), a composite metal oxide represented by LiₛNiₜCoᵤAlᵥO₂ (0.9<s<1.3 and 0.9<t+u+v<1.1), and the like.

As the positive electrode active material and the negative electrode active material, those exemplified above may be used alone, or a plurality of types may be mixed and used.

The carbon material is used under conditions that it burns by firing and does not volatilize. For example, graphite, carbon nanotubes, graphene, acetylene black, ketjen black, etc. are used and calcined in a reducing atmosphere to prevent the carbon material from volatilizing.

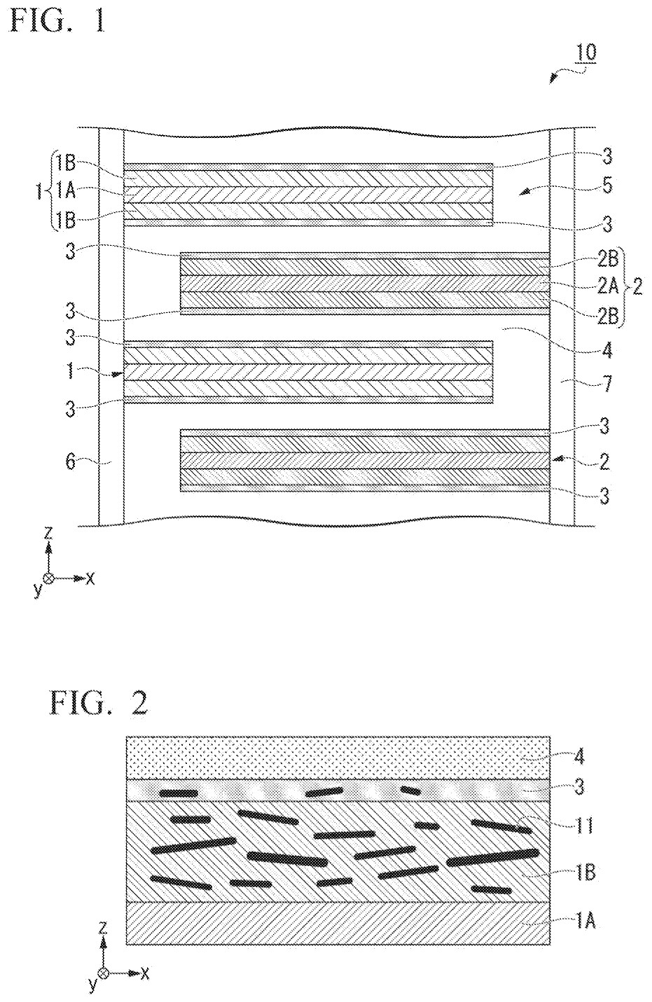

The shape of the carbon material may be flat, tubular, needle-shaped, spherical, or the like, but a material having a large aspect ratio as shown in FIG. 2 is preferable.

FIG. 2 is an enlarged view of the vicinity of the positive electrode layer 1 of the all-solid-state battery according to the present embodiment. The carbon material 11 is mainly dispersed in the positive electrode active material layer 1B. The size of the carbon material is, for example, a major axis of 0.2 to 40 μm and a minor axis of 0.1 to 5 μm.

As a method for measuring the size of a carbon material, first, an all-solid-state battery is polished or cut to obtain a cross section, and then an SEM cross-section observation image is taken. Then, a carbon material having a minor axis of 0.1 μm or more is marked from the obtained SEM observation image by image processing or visual inspection, and then the particle size is analyzed by image analysis to obtain the major axis and the minor axis.

The particle size is analyzed by image analysis, and the average of the obtained major axis and the average of the minor axis are calculated as the size of the carbon material in the present embodiment.

It is preferable that the distribution of the carbon material 11 is the same on the negative electrode layer 2 side as well.

There is no clear distinction between the active materials constituting the positive electrode active material layer 1B and the negative electrode active material layer 2B, and the potentials of the two types of compounds are compared, and a compound showing a more noble potential is used as the positive electrode active material and a compound showing a lower potential can be used as the negative electrode active material.

### (Solid Electrolyte Layer)

The solid electrolyte layer 4 is located between the positive electrode layer 1 and the negative electrode layer 2, respectively. The solid electrolyte layers 4 adjacent to each other in the z direction are connected to the same material as the solid electrolyte layer 4, between the positive electrode layer 1 and the second external terminal 7 and between the negative electrode layer 2 and the first external terminal 6.

The solid electrolyte layer 4 contains a solid electrolyte. The solid electrolyte is a substance (for example, particles) in which ions can be moved by an electric field applied from the outside. For example, lithium ions move in a solid electrolyte by an externally applied electric field. The solid electrolyte is an insulator that inhibits the movement of electrons.

The solid electrolyte layer 4 may contain a carbon material. The carbon content contained in the solid electrolyte layer 4 may be, for example, 100 ppm or more and 10,000 ppm or less.

The solid electrolyte contains, for example, lithium. The solid electrolyte may be, for example, either an oxide-based material or a sulfide-based material. The solid electrolyte may be, for example, any of a Perovskite type compound, a LISICON type compound, a Garnet type compound, a NASICON type compound, a Thio-LISICON type compound, a glass compound, and a phosphoric acid compound. La_{0.5}Li_{0.5}TiO₃ is an example of the Perovskite type compound. Li₁₄Zn(GeO₄)₄ is an example of the LISICON type compound. Li₇La₃Zr₂O₁₂ is an example of the Garnet type compound. LiZr₂(PO₄)₃, Li_{1.3}Al_{0.3}Ti_{1.7}(PO4)₃, Li_{1.5}Al_{0.5}Ge_{1.5}(PO₄)₃, Li_{1.55}Al_{0.2}Zr_{1.7}Si_{0.25}P_{9.75}O₁₂, Li_{1.4}Na_{0.1}Zr_{1.5}Al_{0.5}(PO₄)₃, Li_{1.4}Ca_{0.25}Er_{0.3}Zr_{1.7}(PO₄)_{3.2}, and Li_{1.4}Ca_{0.25}Yb_{0.3}Zr_{1.7}(PO₄)_{3.2} are examples of the NASICON type compound. Li_{3.25}Ge_{0.25}P_{0.75}S₄ and Li₃PS₄ are examples of the Thio-LISICON type compound. Li₂S—P₂S₅ and Li₂O—V₂O₅—SiO₂ are examples of the glass compound. Li₃PO₄, Li_{3.5}Si_{0.5}P_{0.5}O₄, and Li_{2.9}PO_{3.3}N_{0.46} are examples of the phosphoric acid compound. The solid electrolyte may contain one or more of these compounds.

The shape of the solid electrolyte is not particularly limited. The shape of the solid electrolyte is, for example, spherical, ellipsoidal, needle-like, plate-like, scaly, tubular, wire-like, rod-like, or an irregular shape. The particle size of the solid electrolyte is, for example, 0.1 μm or more and 10 μm or less, and may be 0.3 μm or more and 9 μm or less. As a method for measuring the particle size of particles, first, an all-solid-state battery is polished or cut to obtain a cross section, and then heat treatment or chemical treatment is performed to make the grain boundaries stand out and take an SEM cross section observation image. Then, after marking the grain boundaries of the solid electrolyte from the obtained SEM observation image by image processing or visual inspection, the particle size is analyzed by image analysis to obtain the particle size.

### (Intermediate Layer)

The intermediate layer 3 extends in the xy plane and is arranged so as to be in contact with at least a part between the positive electrode layer 1 and the solid electrolyte layer 4, and at least a part between the negative electrode layer 2 and the solid electrolyte layer 4. The intermediate layer 3 plays an important role in improving the bonding between the positive electrode layer 1 and the solid electrolyte layer 4 and the bonding between the negative electrode layer 2 and the solid electrolyte layer 4. The intermediate layer 3 has good ion conductivity because lithium ions can easily move between the positive electrode layer 1 and the solid electrolyte layer 4 and between the negative electrode layer 2 and the solid electrolyte layer 4. The interface between the positive electrode layer 1 or the negative electrode layer 2 in contact with the intermediate layer and the solid electrolyte layer 4 is good, and the movement of lithium ions at the interface is easy.

The composition of the intermediate layer 3 arranged so as to be in contact between the positive electrode layer 1 and the solid electrolyte layer 4 and the composition of the intermediate layer 3 arranged so as to be in contact with the negative electrode layer 2 and the solid electrolyte layer 4 may be the same or different.

It is important that the composition of the intermediate layer 3 is configured so that the composition of the respective contacting layers and the interface bonding are good, and the movement of lithium ions at the interface is easy.

In the present embodiment, an all-solid-state battery 10 includes a solid electrolyte layer 4, an electrode layer (a positive electrode layer 1 or a negative electrode layer 2), an intermediate layer provided at least in a part between the electrode layer and the solid electrolyte layer, the electrode layer (a positive electrode layer 1 or a negative electrode layer 2) includes a current collector layer (a positive current collector layer 1A or a negative current collector layer 2A) and an active material layer (a positive active material layer 1B or a negative active material layer 2B), the active material layer (a positive active material layer 1B or a negative active material layer 2B) includes an active material and a carbon material, the intermediate layer 3 has ionic conductivity, the carbon content the intermediate layer 3 is less than the carbon content in the active material layer. The ionic conductivity of the intermediate layer 3 is preferably 1×10⁻⁶ S/cm or more.

According to this configuration, by having the intermediate layer, the active material layer containing the active material and the carbon material and the solid electrolyte layer can be strongly bonded via the intermediate layer, and the element body strength of the all-solid-state battery can be improved.

It is considered that this is because the gap formed at the interface between the carbon material and the solid electrolyte is suppressed by arranging the intermediate layer having less carbon component than the active material layer between the active material layer and the solid electrolyte layer. As a result, the active material layer and the solid electrolyte layer are strongly bonded to each other via the intermediate layer, and the element body strength of the all-solid-state battery is improved.

Further, it is preferable that the ratio T1/T2 of the thickness T1 of the intermediate layer 3 to the thickness T2 of the active material layer (a positive active material layer 1B or a negative active material layer 2B) satisfies 0.05≤T1/T2≤1.2.

According to this configuration, when T1/T2 satisfies 0.05≤T1/T2≤1.2, the active material layer and the intermediate layer can be strongly bonded to each other, the energy density of the all-solid-state battery is not lowered and the element body strength can be improved.

When T1/T2 is smaller than 0.05, the bonding between the active material layer and the intermediate layer is not sufficient, and the element body strength is weak. When T1/T2 is larger than 1.2, the lithium ion conductive layer becomes thick, which leads to an increase in the internal resistance of the all-solid-state battery, which is not preferable.

Further, the carbon content in the intermediate layer 3 is preferably 100 ppm or more and 50,000 ppm or less.

According to this configuration, the intermediate layer 3 has a carbon content of 100 ppm or more and 50,000 ppm or less, so that the active material layer containing the active material and the carbon material and the solid electrolyte layer can be strongly bonded via the intermediate layer, and the element body strength of the all-solid-state battery can be improved.

Further, the intermediate layer 3 is preferably composed of elements contained in an active material layer (positive electrode active material layer 1B or negative electrode active material layer 2B) in contact with the intermediate layer 3 and elements contained in the solid electrolyte layer 4 in contact with the intermediate layer 3.

According to this configuration, the intermediate layer 3 is composed of elements contained in an active material layer (positive electrode active material layer 1B or negative electrode active material layer 2B) and elements contained in the solid electrolyte layer 4, so that the active material layer (positive electrode active material layer 1B or negative electrode active material layer 2B) containing the active material and the carbon material and the solid electrolyte layer 4 can be strongly bonded via the intermediate layer, and the element body strength of the all-solid-state battery can be improved.

Further, it is preferable that the content of the carbon material in the active material layer (positive electrode active material layer 1B or negative electrode active material layer 2B) increases as the distance from the surface in contact with the intermediate layer increases.

According to this configuration, by suppressing the carbon content of the active material layer near the intermediate layer, the active material layer containing the active material and the carbon material and the intermediate layer can be strongly bonded, and the element body strength of the all-solid-state battery can be improved.

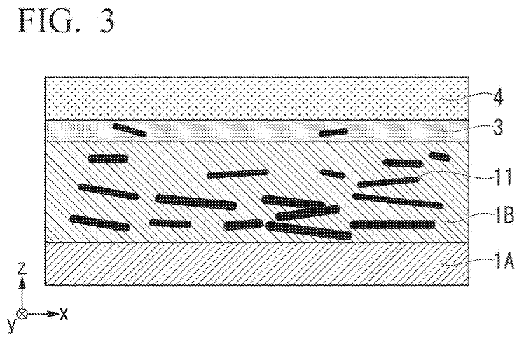

FIG. 3 is an enlarged view of the vicinity of the positive electrode layer 1 of the all-solid-state battery according to the first modification, and is a figure showing that the content of the carbon material in the active material layer (positive electrode active material layer 1B or negative electrode active material layer 2B) increases as the distance from the surface in contact with the intermediate layer 3 increases. At least, when the positive electrode active material layer 1B is bisected in the z direction (thickness direction), it is preferable that the positive electrode current collector 1A side has a higher carbon material content than the intermediate layer 3 side.

It is preferable that the carbon contents in the active material layer, the solid electrolyte layer, and the intermediate layer are higher in the order of the active material layer, the intermediate layer, and the solid electrolyte layer.

According to this configuration, distortion due to the difference in shrinkage behavior during firing due to the difference in carbon content at the interface between the active material layer and the intermediate layer and the interface between the intermediate layer and the solid electrolyte layer is unlikely to occur, and the bonding strength can be increased.

It is preferable that the carbon material in the active material layer contains at least one selected from graphite or carbon nanotubes.

According to this configuration, since, compared to amorphous carbon, graphite and carbon nanotubes have a strong mechanical strength of the carbon material itself and are difficult to volatilize in the debindering/firing process, defects are unlikely to occur in the active material layer, and the element body strength of the all-solid-state battery can be improved.

### (Margin Layer)

When the electrode layer or the intermediate layer is printed on the solid electrolyte sheet by screen printing, a step is generated between the unprinted portion and the portion where the electrode layer or the intermediate layer is printed. In order to eliminate the step, it is preferable that paste for a margin layer is printed on the unprinted portion, and a margin layer is provided to eliminate the step between the unprinted portion and the portion on which the electrode layer or the intermediate layer is printed.

By this step, the stress at the time of laminating the sheets in the production of the laminated body can be reduced, and a high quality laminated body can be obtained. Since the step between the solid electrolyte layer 4 and the positive electrode layer 1 and the step between the solid electrolyte layer 4 and the negative electrode layer 2 are eliminated due to the presence of the margin layer, the denseness between the solid electrolyte layer 4 and each electrode layer is increased, and delamination and warpage due to firing of the all-solid-state battery are less likely to occur.

### (Terminal)

For the first external terminal 6 and the second external terminal 7, for example, a material having excellent conductivity is used. The first external terminal 6 and the second external terminal 7 are, for example, silver, gold, platinum, aluminum, copper, tin, or nickel. The first external terminal 6 and the second external terminal 7 may have a single layer or a plurality of layers.

### (Protective Layer)

The all-solid-state secondary battery 10 may have a protective layer on the outer surface that electrically, physically, and chemically protects the laminated body 4 and the terminals. It is preferable that the protective layer has, for example, excellent insulation, excellent durability and excellent moisture resistance, and is made of an environmentally safe material. The protective layer is, for example, glass, ceramics, a thermosetting resin, or a photocurable resin. Only one kind of protective layer material may be used, or a plurality of kinds of protective layer materials may be used in combination. The protective layer may be a single layer or a plurality of layers. The protective layer is preferably an organic-inorganic hybrid in which a thermosetting resin and ceramic powder are mixed.

Next, a method for manufacturing the all-solid-state secondary battery according to the present embodiment will be described.

The all-solid-state secondary battery 10 may be manufactured by a simultaneous firing method or a sequential firing method. The simultaneous firing method is a method of laminating materials forming each layer and then firing them all at once. The sequential firing method is a method in which each layer is fired each time it is laminated. The simultaneous firing method has a simpler work process than the sequential firing method. Further, the laminated body 4 produced by the simultaneous firing method is denser than the laminated body 4 produced by the sequential firing method. Hereinafter, a case where the simultaneous firing method is used will he described as an example.

First, a paste for each layer constituting the laminated body 4 is prepared. Materials to be the positive electrode current collector layer 1A, the positive electrode active material layer 1B, the solid electrolyte layer 3, the negative electrode active material layer 2B, and the negative electrode current collector layer 2A are each made into a paste. A method of making materials into pastes is not particularly limited. For example, a paste may be obtained by mixing powders of materials in a vehicle. Here, the vehicle is a general term for a medium in a liquid phase. The vehicle includes a solvent and a binder.

A filler is added to at least one of the vehicles of the positive electrode active material layer 1B and the negative electrode active material layer 2B. The filler is, for example, a debinder, a resin material, or a carbon material. All fillers volatilize during firing. The carbon material used as a filler volatilizes during firing and is distinguishable from conductive additives. The filler is, for example, scaly graphite or a pore-forming material. The pore-forming material is, for example, resin particles such as polyethylene and polypropylene. The filler has anisotropy in shape. The aspect ratio obtained by dividing the length of the filler in the major axis direction by the length thereof in the minor axis direction is 2 or more and 29 or less. The filler volatilizes during firing to form an anisotropic void V1.

Next, a green sheet is prepared. The green sheet is a paste processed into a sheet. The green sheet is obtained, for example, by applying the paste to a substrate such as PET (polyethylene terephthalate) in a desired order, drying the paste as necessary, and then peeling the paste from the substrate. The method of applying the paste is not particularly limited. For example, known methods such as screen printing, coating, transfer, and doctor blade can be adopted.

When producing the green sheet of the positive electrode active material layer 1B and the negative electrode active material layer 2B, the carbon material can be oriented in the in-plane direction by controlling the coating speed or coating through a mesh having an opening. When the carbon material is oriented in the in-plane direction, the carbon material is oriented in the in-plane direction in the positive electrode active material layer 1B and the negative electrode active material layer 2B after production.

Each of the produced green sheets is stacked in a desired order and a desired number of layers. Alignment, cutting, etc. are performed as necessary to prepare a laminated body. When producing a parallel type or series-parallel type battery, the positive electrode collector layer and the negative electrode current collector layer are aligned so that the end faces of the positive electrode current collector layer and the end faces of the negative electrode current collector layer do not match.

The laminated body may be produced after preparing the positive electrode active material layer unit and the negative electrode active material layer unit described below.

First, a paste for a solid electrolyte layer is formed on a PET film in the form of a sheet by the doctor blade method, and dried. Next, a paste for the positive electrode active material layer is printed on the green sheet of the solid electrolyte layer by screen printing and dried.

Next, a paste for the positive electrode current collector layer is printed on the dried paste for the positive electrode active material layer by screen printing and dried. Further, a paste for the positive electrode active material layer is printed again by screen printing on the dried paste for the positive electrode current collector layer, and dried. Then, the positive electrode unit is manufactured by peeling off the PET film. In the positive electrode unit, a solid electrolyte layer3/a positive electrode active material layer 1B/a positive electrode current collector layer 1A/a positive electrode active material layer 1B are laminated in this order.

A negative electrode unit is also manufactured by the same procedure. In the negative electrode unit, a solid electrolyte layer 3/a negative electrode active material layer 2B/a negative electrode current collector layer 2A a negative electrode active material layer 2B are laminated in this order.

Next, the positive electrode unit and the negative electrode unit are laminated. The positive electrode unit and the negative electrode unit are laminated so that the solid electrolyte layers of the respective units do not face each other. The laminated body is composed of the positive electrode active material layer 1B positive electrode current collector layer 1A positive electrode active material layer 1B solid electrolyte layer 3/negative electrode active material layer 2B/negative electrode current collector layer 2A negative electrode active material layer 2B/solid electrolyte layers 3 are laminated in this order. The positive electrode unit and the negative electrode unit are laminated so as to be offset so that the positive electrode current collector layer 1A is exposed to the first end surface of the laminated body and the negative electrode current collector layer 2A is exposed to the second end surface opposite to the first end surface. For example, a solid electrolyte layer sheet having a predetermined thickness is further laminated on the uppermost layer and the lowermost layer in the laminating direction and dried.

Next, the produced laminated body is compressed together. Compression is performed while heating. The heating temperature is, for example, 40 to 95° C. Next, the compressed laminated body is sintered. Sintering is performed, for example, by heating in a temperature range of 500° C. or higher and 1000° C. or lower in a nitrogen atmosphere. The firing time is, for example, 0.1 to 3 hours. The laminated body 4 is obtained by sintering.

The sintered body may be put into a cylindrical container together with an abrasive material such as alumina and subjected to barrel polishing. The corners of the sintered body are chamfered by polishing. Polishing may be performed by sandblasting or the like.

Then, the first external terminal 6 and the second external terminal 7 are attached to the laminated body 5. The first external terminal 6 and the second external terminal 7 are formed so as to be in electrical contact with the positive electrode current collector layer 1A or the negative electrode current collector layer 2A, respectively. For example, the first external terminal 6 is connected to the positive electrode current collector layer 1A exposed from the side surface of the laminated body 4, and the second external terminal 7 is connected to the negative electrode current collector layer 2A exposed from the side surface of the laminated body 4. The first external terminal 6 and the second external terminal 7 can be manufactured by, for example, a sputtering method, a screen printing method, a dipping method, a spray coating method, or the like. In the screen printing method and the dipping method, a paste for an external electrode containing a metal powder, a resin, and a solvent is prepared and formed as a first external terminal 6 and a second external terminal 7. Next, a baking step for removing the solvent and a plating process for forming terminal electrodes on the surfaces of the first external terminal 6 and the second external terminal 7 are performed. On the other hand, in the sputtering method, since the external electrode and the terminal electrode can be directly formed, the baking step and the plating process are not required.

The all-solid-state battery 10 may be sealed in, for example, a coin cell in order to improve moisture resistance and impact resistance. The sealing method is not particularly limited, and for example, the laminated body after firing may be sealed with a resin. Further, an insulating paste having an insulating property such as Al₂O₃ may be applied or dip-coated around the laminated body, and the insulating paste may be heat-treated to be sealed.

Although the embodiment according to the present invention has been described in detail above, the embodiment is not limited to the above embodiment and can be variously modified.

### EXAMPLES

Hereinafter, the present invention will be described in more detail with reference to Examples and Comparative Examples based on the above-described embodiments, but the present invention is not limited to these examples. In addition, the indication of “parts” of the amount of the material charged in the preparation of the paste means “parts by mass” unless otherwise specified.

### Example 1

The all-solid-state battery of Example 1 was produced as follows.

### (Fabrication of Active Material)

As the active material, vanadium phosphate titanium lithium prepared by the following method was used. As a method for producing the same, using Li₂CO₃, V₂O₅, TiO₂ and NH₄H₂PO₄ as starting materials, they were wet-mixed with a ball mill for 16 hours, dehydrated and dried, and then the obtained powder was calcined at 850° C. for 2 hours in a nitrogen-hydrogen mixed gas. The calcined product was wet-pulverized with a ball mill and then dehydrated and dried to obtain an active material. It was confirmed by using an X-ray diffractometer that the produced powder had the same crystal structure as Li₃VTi (PO₄)₃.

### (Fabrication of Paste for Active Material Layer)

In fabrication of paste for active material layer, 15 parts of ethyl cellulose as a binder and 65 parts of dihydroterpineol as a solvent were added to 96 parts of the active material powder and 4 parts of the flat carbon material (graphite: TIMREX (registered trademark) Graphite: KS-6L) powder obtained, and mixed and dispersed to fabricate paste for the active material layer.

### (Fabrication of Solid Electrolyte)

As a solid electrolyte, an LATP-based NASICON type compound prepared by the following method (e.g., Li_{1.3}Al_{0.3}Ti_{1.7} (PO₄)₃) was used. As a method for producing the same, using Li₂CO₃, Al₂O₃, TiO₂ and NH₄H₂PO₄ as starting materials, they were wet-mixed with a ball mill for 16 hours, dehydrated and dried, and then the obtained powder was calcined at 800° C. for 2 hours in the air. After calcining, it was wet-pulverized with a ball mill for 16 hours and then dehydrated and dried to obtain a solid electrolyte powder. It was confirmed by using an X-ray diffractometer (XRD) that the produced powder had the same crystal structure as the LATP-based solid electrolyte.

### (Fabrication of Paste for Solid Electrolyte Layer)

For fabrication of paste for solid electrolyte layer, with respect to 100 parts of the solid electrolyte powder, 100 parts of ethanol and 200 parts of toluene were added as solvents and wet-mixed with a ball mill, and then, 16 parts of a polyvinyl butyral binder and 4.8 parts of benzyl butyl phthalate are further added and mixed to obtain a paste for a solid electrolyte layer.

### (Fabrication of Sheet for Solid Electrolyte Layer)

A sheet for the solid electrolyte layer was formed by a doctor blade method using a PET film as a base material to obtain a sheet for a solid electrolyte layer having a thickness of 15 μm.

### (Fabrication of Paste for Electrode Current Collector Layer)

After mixing Cu and vanadium phosphate titanium lithium, which is an active material, in a volume ratio of 80/20, 100 parts of this mixture, 10 parts of ethyl cellulose as a binder, and 50 parts of dihydroterpineol as a solvent are added, and then mixed and dispersed to obtain a paste for the current collector layer.

### (Fabrication of Base Material for Intermediate Layer)

For fabrication of base material for intermediate layer, the vanadium phosphate titanium lithium powder fabricated as an active material and the LATP-based NASICON-type compound powder fabricated using a solid electrolyte were wet-mixed with a ball mill for 16 hours, and the powder obtained after dehydration drying was calcined at 850° C. for 2 hours in a nitrogen-hydrogen mixed gas. The calcined product was wet-pulverized with a ball mill and then dehydrated and dried to obtain base material powder for an intermediate layer.

### (Fabrication of Paste for Intermediate Layer)

For fabrication of paste for intermediate layer, 15 parts of ethyl cellulose as a binder and 65 parts of dihydroterpineol as solvent were added to 100 parts of the base material powder for the intermediate layer, mixed and dispersed to fabricate a paste for the intermediate layer.

### (Fabrication of Paste for Margin Layer)

For fabrication of paste for margin layer, 100 parts of ethanol and 100 parts of toluene were added as solvent to 100 parts of the powder of the LATP-based NASICON-type compound and wet-mixed with a ball mill, and then 16 parts of the polyvinyl butyral-based binder and 4.8 parts of benzyl butyl phthalate are further added and mixed to fabricate a paste for a margin layer.

### (Fabrication of Paste for Electrode External)

Silver powder, an epoxy resin and a solvent are mixed and dispersed to fabricate thermosetting external electrode paste.

Using these pastes, an all-solid-state battery was fabricated as follows.

### (Fabrication of Positive Electrode Unit)

An intermediate layer having a thickness of 0.2 μm (referred to as a first positive electrode intermediate layer) was formed on the solid electrolyte layer sheet by screen printing, and dried at 80° C. for 10 minutes. Next, a positive electrode active material layer (referred to as a first positive electrode active material layer) having a thickness of 5 μm was formed thereon by screen printing, and dried at 80° C. for 10 minutes. Further, a positive electrode current collector layer having a thickness of 5 μm was formed thereon by screen printing, and dried at 80° C. for 10 minutes. Further, a positive electrode active material layer (referred to as a second positive electrode active material layer) having a thickness of 5 μm is formed thereon again by screen printing. Further, an intermediate layer having a thickness of 0.2 μm (referred to as a second positive electrode intermediate layer) was formed thereon again by screen printing, and a positive electrode layer was fabricated on the solid electrolyte layer sheet by drying at 80° C. for 10 minutes. Next, a margin layer having substantially the same height as the positive electrode was formed on the outer periphery of one end of the positive electrode by screen printing, and dried at 80° C. for 10 minutes. Then, the PET film was peeled off to obtain a sheet of the positive electrode unit.

### (Fabrication of Negative Electrode Unit)

An intermediate layer having a thickness of 0.2 μm (referred to as a first negative electrode intermediate layer) was formed on the solid electrolyte layer sheet by screen printing, and dried at 80° C. for 10 minutes. Next, a negative electrode active material layer (referred to as a first negative electrode active material layer) having a thickness of 5 μm was formed thereon, and dried at 80° C. for 10 minutes. Further, a negative electrode current collector layer having a thickness of 5 μm was formed thereon by screen printing, and dried at 80° C. for 10 minutes. Further, a negative electrode active material layer (referred to as a second negative electrode active material layer) having a thickness of 5 μm is formed thereon again by screen printing. Further, an intermediate layer having a thickness of 0.2 μm (referred to as a second negative electrode intermediate layer) was formed thereon again by screen printing, and a negative electrode layer was fabricated on the solid electrolyte layer sheet by drying at 80° C. for 10 minutes. Next, a margin layer having substantially the same height as the positive electrode was formed on the outer periphery of one end of the negative electrode by screen printing, and dried at 80° C. for 10 minutes. Then, the PET film was peeled off to obtain a sheet of the negative electrode unit.

### (Fabrication of Laminated Body)

A plurality of positive electrode units and negative electrode units were alternately laminated while being offset so that one end of each unit did not match, and a laminated substrate was produced. Further, a plurality of solid electrolyte sheets were laminated as outer layers on both main surfaces of the laminated substrate, and an outer layer of 200 μm was provided. This was bonded by thermocompression using a die press and then cut to obtain an unfired all-solid-state battery laminated body. Next, the laminated body was debindered and fired to obtain a laminated body of an all-solid-state battery. The firing was carried out in nitrogen at a temperature rising rate of 200° C./hour to a firing temperature of 750° C., maintained at that temperature for 2 hours, and taken out after natural cooling.

### (External Electrode Forming Process)

External terminal paste was applied to the end face of the laminate of the all-solid-state battery and heat-cured at 150° C. for 30 minutes to form a pair of external electrodes.

The dimensions of the produced all-solid-state battery were approximately 4.5 mm×3.2 mm×1.1 mm.

### Example 2 to Example 6

The all-solid-state batteries according to Example 2 to Example 6 were produced in the same manner as in Example 1 except that the print thickness of the intermediate layer was adjusted so that the ratio T1/T2 of the thickness T1 of the intermediate layer and the thickness T2 of the active material layer would be the values shown in Table 1, respectively.

### Example 7 to Example 10

The all-solid-state batteries according to Example 7 to Example 10 were produced in the same manner as in Example 4 except that a carbon material was added to the paste for the intermediate layer and/or the debindering conditions were adjusted so that the carbon content contained in the intermediate layer would be the values shown in Table 1, respectively.

### Example 11

In the all-solid-state battery according to Example 11, LiCoPO₄ prepared by the following method was used as positive electrode active material. As a method for producing the same, using Li₂CO₃, CoO and NH₄H₂PO₄ as starting materials, they were wet-mixed with a ball mill for 16 hours, dehydrated and dried, and then the obtained powder was calcined at 850° C. for 2 hours in the air. The calcined product was wet-pulverized with a ball mill and then dehydrated and dried to obtain positive electrode active material powder. It was confirmed by using an X-ray diffractometer that the produced powder had the same crystal structure as LiCoPO₄.

Then, in fabrication of base material for positive electrode intermediate layer, LiCoPO₄ powder fabricated as a positive electrode active material and the LATP-based solid electrolyte powder fabricated as a solid electrolyte were wet-mixed with a ball mill for 16 hours, and the powder obtained after dehydration drying was calcined at 850° C. for 2 hours in a nitrogen-hydrogen mixed gas. The calcined product was wet-pulverized with a ball mill and then dehydrated and dried to obtain base material powder for a positive electrode intermediate layer, and using this, a paste for the positive electrode intermediate layer was prepared and used for forming the positive electrode intermediate layer.

The all-solid-state battery was produced in the same manner as in Example 3 except that the obtained positive active material and the obtained positive electrode intermediate layer base material were used.

### Example 12

In the all-solid-state battery according to Example 12, the LZP-based NASICON type compound prepared by the following method was used as solid electrolyte. As a method for producing the same, using Li₂CO₃, ZrO₂, CaCO₃ and NH₄H₂PO₄ as starting materials, they were wet-mixed with a ball mill for 16 hours, dehydrated and dried, and then the obtained powder was calcined at 900° C. for 2 hours in the air. The calcined product was wet-pulverized with a bail mill and then dehydrated and dried to obtain solid electrolyte powder. It was confirmed by using an X-ray diffractometer (XRD) that the produced powder had the same crystal structure as LiZr₂ (PO₄)₃.

The all-solid-state battery was produced in the same manner as in Example 4 except for using the prepared LZP-based NASICON type compound and setting the firing temperature to 1000° C.

### Example 13

In the all-solid-state battery according to Example 13, Li₃ Fe₂ (PO₄)₃ prepared by the following method was used as positive electrode active material. As a method for producing the same, using Li₂CO₃, Fe₂O₃ and NH₄H₂PO₄ as starting materials, they were wet-mixed with a ball mill for 16 hours, dehydrated and dried, and then the obtained powder was calcined at 850° C. for 2 hours in the air. The calcined product was wet-pulverized with a ball mill and then dehydrated and dried to obtain positive electrode active material powder. It was confirmed by using an X-ray diffractometer that the produced powder had the same crystal structure as Li₃ Fe₂ (PO₄)₃.

Next, in fabrication of base material for positive electrode intermediate layer, LiCoPO₄ powder fabricated as a positive electrode active material and the LATP-based solid electrolyte powder fabricated as a solid electrolyte were wet-mixed with a ball mill for 16 hours, and the powder obtained after dehydration drying was calcined at 850° C. for 2 hours in a nitrogen-hydrogen mixed gas. The calcined product was wet-pulverized with a ball mill and then dehydrated and dried to obtain base material powder for a positive electrode intermediate layer.

Li₄Ti₅O₁₂ prepared by the following method was used as negative electrode active material. As a method for producing the same, using Li₂CO₃ and TiO₂ as starting materials, they were wet-mixed with a ball mill for 16 hours, dehydrated and dried, and then the obtained powder was calcined at 1000° C. for 2 hours in the air. The calcined product was wet-pulverized with a ball mill and then dehydrated and dried to obtain negative electrode active material powder. It was confirmed by using an X-ray diffractometer that the produced powder had the same crystal structure as Li₄Ti₅O₁₂.

Then, in fabrication of base material for negative electrode intermediate layer, LiCoPO₄ powder fabricated as a negative electrode active material and the LATP-based solid electrolyte powder fabricated as a solid electrolyte were wet-mixed with a ball mill for 16 hours, and the powder obtained after dehydration drying was calcined at 850° C. for 2 hours in a nitrogen-hydrogen mixed gas. The calcined product was wet-pulverized with a ball mill and then dehydrated and dried to obtain base material powder for a negative electrode intermediate layer.

The all-solid-state battery was produced in the same manner as in Example 3 except that the obtained positive active material and the obtained negative active material, and the obtained positive electrode intermediate layer base material were used.

### Example 14

The all-solid-state battery according to Example 14 was produced in the same manner as in Example 4 except that the base material obtained by the following manufacturing method was used to fabricate the base material for the intermediate layer.

In fabrication of base material for intermediate layer, Li₃VTi (PO₄)₃ powder fabricated as positive electrode active material and negative electrode active material and ZrO₂ powder wet-mixed with a ball mill for 16 hours, and the powder obtained after dehydration drying was calcined at 850° C. for 2 hours in a nitrogen-hydrogen mixed gas. The calcined product was wet-pulverized with a ball mill and then dehydrated and dried to obtain base material powder for an intermediate layer.

### Example 15 to Example 17

The all-solid-state batteries according to Example 15 to Example 17 were produced in the same manner as in Example 4 except that spherical 1 (graphite), tubular, and spherical 2 (amorphous carbon) carbon materials shown in Table 1 were used as carbon materials in the preparation of the positive electrode active material layer paste and the negative electrode active material layer paste, respectively.

### Example 18

The all-solid-state battery according to Example 18 was produced so that the content of the carbon material in the positive electrode active material layer and the negative electrode active material layer increases as the distance from the surface in contact with the intermediate layer increases.

Specifically, in fabrication of paste for positive electrode active material layer and paste for negative electrode active material layer, 15 parts of ethyl cellulose as a binder and 65 parts of dihydroterpineol as a solvent were added to 95 parts of the Li₃VTi (PO₄)₃ powder and 5 parts of the flat carbon material (graphite: TIMREX (registered trademark) Graphite: KS-6L) powder obtained, and mixed and dispersed to fabricate paste for positive electrode active material layer and paste for negative electrode active material layer (paste A), and 15 parts of ethyl cellulose as a binder and 65 parts of dihydroterpineol as a solvent were added to 97 parts of the Li₃VTi (PO₄)₃ powder and 3 parts of the flat carbon material (graphite: TIMREX (registered trademark) Graphite: KS-6L) powder obtained, and mixed and dispersed to fabricate paste for positive electrode active material layer and paste for negative electrode active material layer (paste B).

With these pastes, an intermediate layer having a thickness of 1.5 μm (referred to as a first positive electrode intermediate layer) was formed on the solid electrolyte layer sheet by screen printing, and dried at 80° C. for 10 minutes. Next, paste B was printed thereon by screen printing, a positive electrode active material layer (referred to as a first positive electrode active material layer B) having a thickness of 2.5 μm was formed, and dried at 80° C. for 10 minutes. Further, paste A was printed thereon by screen printing, a positive electrode active material layer (referred to as a first positive electrode active material layer A) having a thickness of 2.5 μm was formed, and dried at 80° C. for 10 minutes. Further, a positive electrode current collector layer having a thickness of 5 μm was formed thereon by screen printing, and dried at 80° C. for 10 minutes. Further, paste A was printed thereon by screen printing, a positive electrode active material layer (referred to as a second positive electrode active material layer A) having a thickness of 2.5 μm was formed again, and dried at 80° C. for 10 minutes. Next, paste B was printed thereon by screen printing, a positive electrode active material layer (referred to as a second positive electrode active material layer B) having a thickness of 2.5 μm was formed again, and dried at 80° C. for 10 minutes. Further, an intermediate layer having a thickness of 1.5 μm (referred to as a second positive electrode intermediate layer) was formed thereon again by screen printing, and a positive electrode layer was fabricated on the solid electrolyte layer sheet by drying at 80° C. for 10 minutes. Next, a margin layer having substantially the same height as the positive electrode was formed on the outer periphery of one end of the positive electrode by screen printing, and dried at 80° C. for 10 minutes. Then, the PET film was peeled off to obtain a sheet of the positive electrode unit. Then, the sheet of the negative electrode layer unit was also produced in the same manner as the sheet of the negative electrode layer unit.

The all-solid-state battery was produced in the same manner as in Example 3 except for the processes described above.

### Comparative Example 1

The all-solid-state battery according to Comparative example 1 was produced in the same manner as in Example 1 except that the intermediate layer was not printed, debindering and firing step was performed under the conditions of atmosphere and firing temperature: profile so that element diffusion does not occur between the active material layer and the solid electrolyte layer.

### Example 19 to Example 30

Example 19 to Example 21 show the results of measuring the carbon content in the active material layer and the solid electrolyte layer in addition to the intermediate layer for the all-solid-state batteries produced in Examples 8 to 10, respectively. Example 22 to Example 30 were produced in the same manner as in Example 4 except that a carbon material was added to the paste for the intermediate layer, the paste for the active material layer, the paste for the solid electrolyte layer and/or the debindering conditions were adjusted so that the carbon content contained in the intermediate layer, the active material layer and the solid electrolyte layer would be the values shown in Table 2, respectively.

### (Evaluation)

The all-solid-state batteries produced in the examples and the comparative examples can be evaluated for the following battery characteristics.

### [Carbon Content in Intermediate Layer, Active Material Layer and Solid Electrolyte Layer]

In the all-solid-state battery produced by these examples, the amount of carbon contained in the intermediate layer, the active material layer and the solid electrolyte layer was measured as follows.

First, the all-solid-state battery is polished while being embedded in a resin such as an epoxy resin to expose the cross section of the intermediate layer. At this time, it is preferable to polish the surface at an angle close to horizontal rather than perpendicular to the laminating direction so that the measurement can be performed on an area as large as possible. Then, the carbon content (concentration) was measured by EPMA (WDS=wavelength dispersive spectroscopy). The measurement conditions were an acceleration voltage of 10 kV, a measurement current of 500 nA, a peak measurement time of 80 seconds, a background measurement time of 20 seconds, and a minimum spot diameter. Measurements were performed using a liquid nitrogen trap to eliminate the effects of measurement errors due to hydrocarbon contamination inside the device. The same applies to the active material layer and the solid electrolyte layer.

### [3-Point Bending Test]

The element body strength of the all-solid-state battery was evaluated by a three-point bending test. The 3-point bending test was evaluated according to JIS R 1601.

### [Internal Resistance]

The AC impedance method was used to measure the internal resistance. In an environment of 30° C., an impedance analyzer was used to apply an AC voltage having an amplitude of 10 mV from a frequency of 10 mHz to 1 MHz with a closed circuit voltage of 0 V, and the impedance was measured from the response current. It was calculated by plotting the measured impedance on a Nyquist diagram and fitting it with an RC parallel circuit.

### (Results)

Table 1 shows the results of the three-point bending test and the internal resistance of the all-solid-state battery according to Example 1 to Example 18 and Comparative Example 1.

Table 2 shows the results of the three-point bending test and the internal resistance of the all-solid-state battery according to Example 19 to Example 30.

TABLE 1

| | | Carbon | | Carbon content in | Constituent | | 3-Point | Internal |
|---|---|---|---|---|---|---|---|---|
| | | material | | intermediate layer | elements of the | Solid | bending test | resistance |
| | Active material | shape | T1/T2 | [ppm] | intermediate layer | electrolyte | [MPa] | [Ω] |
| Example 1 | Li₃VTi(PO₄)₃ | flat | 0.04 | 120 | Li, V, Ti, Al, P, O | LATP-based | 93 | 520 |
| Example 2 | Li₃VTi(PO₄)₃ | flat | 0.06 | 120 | Li, V, Ti, Al, P, O | LATP-based | 104 | 520 |
| Example 3 | Li₃VTi(PO₄)₃ | flat | 0.29 | 120 | Li, V, Ti, Al, P, O | LATP-based | 116 | 540 |
| Example 4 | Li₃VTi(PO₄)₃ | flat | 0.86 | 120 | Li, V, Ti, Al, P, O | LATP-based | 153 | 560 |
| Example 5 | Li₃VTi(PO₄)₃ | flat | 1.14 | 120 | Li, V, Ti, Al, P, O | LATP-based | 159 | 700 |
| Example 6 | Li₃VTi(PO₄)₃ | flat | 1.43 | 120 | Li, V, Ti, Al, P, O | LATP-based | 165 | 810 |
| Example 7 | Li₃VTi(PO₄)₃ | flat | 0.86 | <100 | Li, V, Ti, Al, P, O | LATP-based | 105 | 550 |
| Example 8 | Li₃VTi(PO₄)₃ | flat | 0.86 | 1,000 | Li, V, Ti, Al, P, O | LATP-based | 143 | 560 |
| Example 9 | Li₃VTi(PO₄)₃ | flat | 0.86 | 5,000 | Li, V, Ti, Al, P, O | LATP-based | 101 | 530 |
| Example 10 | Li₃VTi(PO₄)₃ | flat | 0.86 | 7,000 | Li, V, Ti, Al, P, O | LATP-based | 83 | 580 |
| Example 11 | LiCoPO₄ | flat | 0.86 | 120 | Li, Co, Ti, Al, P, O | LATP-based | 143 | 12k |
| | (positive electrode) | | | | | | | |
| | Li₃VTi(PO₄)₃ | | 0.86 | 120 | Li, V, Ti, Al, P, O | | | |
| | (negative electrode) | | | | | | | |
| Example 12 | Li₃VTi(PO₄)₃ | flat | 0.86 | 120 | Li, V, Ti, Ca, P, O | LZP-based | 134 | 700 |
| Example 13 | Li₃Fe₂(PO₄)₃ | flat | 3.0 | 120 | Li, Fe, Ti, Al, P, O | LATP-based | 138 | 20k |
| | (positive electrode) | | | | | | | |
| | Li₄Ti₅O₁₂ | | 3.0 | 120 | Li, Ti, Al, P, O | | | |
| | (negative electrode) | | | | | | | |
| Example 14 | Li₃VTi(PO₄)₃ | flat | 0.86 | 120 | Li, V, Zr, P, O | LATP-based | 101 | 680 |
| Example 15 | Li₃VTi(PO₄)₃ | spherical 1 | 0.86 | 120 | Li, V, Ti, Al, P, O | LATP-based | 120 | 700 |
| Example 16 | Li₃VTi(PO₄)₃ | tubular | 0.86 | 120 | Li, V, Ti, Al, P, O | LATP-based | 132 | 640 |
| Example 17 | Li₃VTi(PO₄)₃ | spherical 2 | 0.86 | 120 | Li, V, Ti, Al, P, O | LATP-based | 99 | 750 |
| Example 18 | Li₃VTi(PO₄)₃ | flat | 0.29 | 120 | Li, V, Ti, Al, P, O | LATP-based | 165 | 660 |
| Comparative | Li₃VTi(PO₄)₃ | flat | 0 | 120 | — | LATP-based | 52 | 460 |
| Example 1 | | | | | | | | |

TABLE 2

| | | | | Carbon | | Carbon | | | | |
|---|---|---|---|---|---|---|---|---|---|---|
| | | | | content in | Carbon | content in | | | | |
| | | | | active | content in | solid | | | 3-Point | |
| | | Carbon | | material | intermediate | electlyte | Constituent | | bending | Internal |
| | Active | material | T1/ | layer | layer | layer | elements of the | Solid | test | resistance |
| | material | shape | T2 | [ppm] | [ppm] | [ppm] | intermediate layer | electlyte | [MPa] | [Ω] |
| Example 1 | Li₃VTi(PO₄)₃ | flat | 0.86 | 43,000 | 1,000 | 340 | Li, V, Ti, Al, P, O | LATP-based | 143 | 560 |
| Example 20 | Li₃VTi(PO₄)₃ | flat | 0.86 | 42,000 | 5,000 | 200 | Li, V, Ti, Al, P, O | LATP-based | 101 | 530 |
| Example 21 | Li₃VTi(PO₄)₃ | flat | 0.86 | 42,000 | 7,000 | 300 | Li, V, Ti, Al, P, O | LATP-based | 83 | 580 |
| Example 22 | Li₃VTi(PO₄)₃ | flat | 0.86 | 40,000 | 10,000 | 300 | Li, V, Ti, Al, P, O | LATP-based | 78 | 600 |
| Example 23 | Li₃VTi(PO₄)₃ | flat | 0.86 | 42,000 | 23,000 | 300 | Li, V, Ti, Al, P, O | LATP-based | 71 | 630 |
| Example 24 | Li₃VTi(PO₄)₃ | flat | 0.86 | 55,000 | 50,000 | 300 | Li, V, Ti, Al, P, O | LATP-based | 63 | 540 |
| Example 25 | Li₃VTi(PO₄)₃ | flat | 0.86 | 40,000 | 10,000 | 1,000 | Li, V, Ti, Al, P, O | LATP-based | 85 | 530 |
| Example 26 | Li₃VTi(PO₄)₃ | flat | 0.86 | 42,000 | 23,000 | 2,100 | Li, V, Ti, Al, P, O | LATP-based | 83 | 500 |
| Example 27 | Li₃VTi(PO₄)₃ | flat | 0.86 | 55,000 | 50,000 | 7,000 | Li, V, Ti, Al, P, O | LATP-based | 81 | 480 |
| Example 28 | Li₃VTi(PO₄)₃ | flat | 0.86 | 40,000 | 1,000 | 2,000 | Li, V, Ti, Al, P, O | LATP-based | 130 | 580 |
| Example 29 | Li₃VTi(PO₄)₃ | flat | 0.86 | 40,000 | 5,000 | 7,200 | Li, V, Ti, Al, P, O | LATP-based | 89 | 520 |
| Example 30 | Li₃VTi(PO₄)₃ | flat | 0.86 | 40,000 | 5,000 | 9,500 | Li, V, Ti, Al, P, O | LATP-based | 75 | 560 |

It was confirmed that the all-solid-state batteries according to Example 1 to Example 30 had better results of the three-point bending test than the all-solid-state batteries according to Comparative Example 1.

It was confirmed that in the all-solid-state battery according to Example 1 to Example 6, particularly when the ratio T1/T2 of the thickness T1 of the intermediate layer and the thickness T2 of the active material layer satisfies 0.05≤T1/T2≤1.2, better three-point bending test results and better internal resistance can be obtained. This is because when T1/T2 is smaller than 0.05, the bonding between the active material layer and the solid electrolyte layer is not sufficient and the element field strength is weaker than when it is 0.05 or more, so the three-point bending test results deteriorates. It is thought that when T1/T2 is larger than 1.2, the distance between the positive electrode and the negative electrode is longer than when it is 1.2 or more, and it becomes difficult for lithium ions to move, so that the internal resistance of the all-solid-state battery increases.

It was confirmed that in the all-solid-state batteries according to Example 4 and Example 7 to Example 10, better three-point bending test results can be obtained, especially when the carbon content in the intermediate layer satisfies 100 ppm or more and 5,000 ppm or less. It is considered that when it is less than 100 ppm, cracks are more likely to occur at the interface between the intermediate layer and the active material layer than when it is 100 ppm or more, while when it is larger than 5,000 ppm, cracks are more likely to occur at the interface between the intermediate layer and the solid electrolyte layer than when it is 5,000 ppm or less.

The all-solid-state battery according to Example 11 is an all-solid-state battery in which the positive electrode active material is changed and the positive electrode active material and the negative electrode active material are different. The all-solid-state battery according to Example 12 is an all-solid-state battery in which the solid electrolyte is changed. The all-solid-state battery according to Example 13 is an all-solid-state battery in which the positive electrode active material and the negative electrode active material are changed, and the positive electrode active material and the negative electrode active material are different. As described above, it was confirmed that even if the positive electrode active material, the solid electrolyte, and the negative electrode active material were changed to various materials, the results of the three-point bending test superior to those of the all-solid-state battery according to Comparative Example 1 were obtained.

On the other hand, it was confirmed that the result of the three-point bending test of the all-solid-state battery according to Example 14 was lower than that of Example 4. This is because the constituent elements of the intermediate layer include Zr, which is not contained in the active material layer and the solid electrolyte layer in contact with the intermediate layer, so that the adhesiveness between the active material layer and the solid electrolyte layer of the intermediate layer was lowered and the result of the three-point bending test was lowered.

The all-solid-state batteries according to Example 15 to Example 17 were all-solid-state batteries in which the carbon material is changed with respect to Example 4. It was confirmed that these all-solid-state batteries had better results of the three-point bending test than the all-solid-state battery according to Comparative Example 1. It was confirmed that Example 17 using the carbon material of amorphous carbon had the result of the three-point bending test, which was slightly lower than that in Example 4, Example 15, and Example 16. It is considered that since amorphous carbon has a weaker mechanical strength and is more likely to volatilize in the debindering/firing process compared to graphite and carbon nanotubes, defects are more likely to occur in the active material layer the result of the three-point bending test is slightly lowered.

The all-solid-state battery according to Example 18 was an all-solid-state battery in which the content of the carbon material in the electrode active material layer increases as the distance from the surface in contact with the intermediate layer increases. It was confirmed that better three-point bending test results can be obtained compared with Example 3 in which the distribution of carbon material is uniform. It is considered that this is because the carbon content of the active material layer near the intermediate layer is suppressed so that the active material layer containing the active material and the carbon material and the intermediate layer can be strongly bonded.

In the all-solid-state battery according to Example 19 to Example 21, the carbon content contained in the intermediate layer is 2.3% to 16.7% as compared with the carbon content contained in the active material layer, and the carbon content contained in the intermediate layer is 2.9 times to 25 times that of the carbon content contained in the intermediate layer. In the all-solid-state battery according to Example 22 to Example 27, the carbon content contained in the intermediate layer is 25% to 90.9% as compared with the carbon content contained in the active material layer, and the carbon content contained in the intermediate layer is 7.1 times to 166.7 times that of the carbon content contained in the intermediate layer. In the all-solid-state battery according to Example 28 to Example 30, the carbon content contained in the intermediate layer is 2.5% to 17.5% as compared with the carbon content contained in the active material layer, and the carbon content contained in the intermediate layer is 0.5 times to 0.74 times that of the carbon content contained in the intermediate layer.

It was confirmed that that better three-point bending test results can be obtained in the all-solid-state battery according to Example 19 to Example 30, in which the carbon content contained in the intermediate layer is about 2% to about 90% as compared with the carbon content contained in the active material layer, compared with the all-solid-state battery according to Comparative Example 1.

It was confirmed that that better three-point bending test results can be obtained in the all-solid-state battery according to Example 19 to Example 30, in which 0.5 times to about 160 times that of the carbon content contained in the intermediate layer, compared with the all-solid-state battery according to Comparative Example 1.
It was confirmed that better three-point bending test results can be obtained when the carbon content contained in the intermediate layer is larger than the carbon content contained in the solid electrolyte layer (Example 19 to Example 27) and vice versa (Example 28 to Example 30).
It was confirmed that comparing Example 19 to Example 21 and Example 28 to Example 30, when the carbon content in the intermediate layer is 7000 ppm or less, better three-point bending test results in the configuration in which the carbon content is higher in the order of the active material layer, the intermediate layer, and the solid electrolyte layer, can be obtained than in the configuration in which the carbon content is higher in the order of the active material layer, the solid electrolyte layer, and the intermediate layer.

Although the present invention has been described in detail above, the embodiments and examples are merely examples, and the inventions disclosed herein include various modifications and modifications of the above-mentioned specific examples.

### REFERENCE SIGNS LIST

1 Positive electrode layer
1A Positive electrode current collector layer
1B Positive electrode active material layer
2 Negative electrode layer
2A Negative electrode current collector layer
2B Negative electrode active material layer
3 Intermediate layer
4 Solid electrolyte layer
5 Laminated body
6 First external terminal
7 Second external terminal
11 Carbon material

1. An all-solid-state battery comprising:
an electrode layer;
a solid electrolyte layer; and
an intermediate layer provided at least in a part between the electrode layer and the solid electrolyte layer,
the electrode layer has a current collector layer and an active material layer,
the active material layer has an active material and a carbon material,
the intermediate layer has ionic conductivity,
the carbon content in the intermediate layer is less than the carbon content in the active material layer.

2. The all-solid-state battery according to claim 1, wherein the ratio T1/T2 of the thickness T1 of the intermediate layer to the thickness T2 of the active material layer satisfies 0.05≤T1/T2≤1.2.

3. The all-solid-state battery according to claim 1, wherein the carbon content in the intermediate layer is 100 ppm or more and 50,000 ppm or less.

4. The all-solid-state battery according to claim 1, wherein the intermediate layer is composed of elements contained the active material layer and elements contained in the solid electrolyte layer.

5. The all-solid-state battery according to claim 1, wherein the content of the carbon material in the active material layer increases as the distance from the surface in contact with the intermediate layer increases.

6. The all-solid-state battery according to claim 1, wherein the carbon contents in the active material layer, the solid electrolyte layer, and the intermediate layer are higher in the order of the active material layer, the intermediate layer, and the solid electrolyte layer.

7. The all-solid-state battery according to claim 1, wherein the current collector layer contains carbon.

8. The all-solid-state battery according to claim 1, wherein the carbon material contains at least one selected from graphite and carbon nanotubes.
